(19) United States
(12) Patent Application Publication
(10) Pub. No.: US 2013/0327513 A1
(43) Pub. Date: Dec. 12, 2013

(54) HEAT EXCHANGER PLATE, PLATE HEAT EXCHANGER PROVIDED THEREWITH AND METHOD FOR MANUFACTURING A HEAT EXCHANGER PLATE

(71) Applicant: SGL CARBON SE, (US)

(72) Inventors: MARCUS FRANZ, SCHWABMUENCHEN (DE); MATTHIAS REITZ, WERDAU (DE)

(73) Assignee: SGL CARBON SE, WIESBADEN (DE)

(21) Appl. No.: 13/731,299

(22) Filed: Dec. 31, 2012

Related U.S. Application Data
(63) Continuation of application No. PCT/EP2011/059638, filed on Jun. 9, 2011.

(30) Foreign Application Priority Data
Jun. 30, 2010 (DE) 10 2010 030 781.5

(51) Int. Cl. F28F 3/00; B23P 15/26

(52) U.S. Cl. CPC F28F 3/00; B23P 15/26
USPC 165/185; 29/890.03

(57) ABSTRACT

A heat exchanger plate for a plate heat exchanger includes a plate substrate formed at least on its upper side with a flow duct configuration having a multiplicity of flow ducts. Some or all of the flow ducts have duct webs, over an entire extent thereof or in sections, forming duct walls delimiting a duct groove of a respective flow duct. A plate heat exchanger and a method for manufacturing a heat exchanger plate for a plate heat exchanger are also provided.

### CROSS-REFERENCE TO RELATED APPLICATION

This is a continuation, under 35 U.S.C. §120, of copending International Application No. PCT/EP2011/059638, filed Jun. 9, 2011, which designated the United States; this application also claims the priority, under 35 U.S.C. §119, of German Patent Application DE 10 2010 030 781.5, filed Jun. 30, 2010; the prior applications are herewith incorporated by reference in their entirety.

### BACKGROUND OF THE INVENTION

### Field of the Invention

The present invention relates to a heat exchanger plate, a plate heat exchanger provided with the heat exchanger plate, as well as a method for manufacturing a heat exchanger plate. The present invention also relates, in particular, to a plate heat exchanger with ceramic plates.

In heat exchangers or recuperators for exchanging a quantity of heat between two fluids or gaseous media that do not come into contact with each other and must not be blended together, so-called plate heat exchangers or plate recuperators are often used, in which the region for exchanging the heat between the two media is formed by stacking so-called heat exchanger plates or recuperator plates, which lie against or on top of each other like a packet, wherein directly adjacent heat exchanger plates establish a flow space between them, directly adjacent flow spaces are separated from each other in terms of flow, and each are allocated to one of the two media. Therefore, an odd number of consecutive flow spaces in the stack or packet in that case carry a first medium and an even number of consecutive flow spaces in the stack or packet carry a second medium, without there being any blending. In this case the heat is exchanged through the heat exchanger plates that respectively border and separate the flow spaces, so that they serve as boundary walls for the flow spaces, and are sealed relative to each other through the provision of corresponding gaskets.

Known heat exchanger plates are made of metal, for example, so that a configuration thereof formed of a plurality of heat exchanger plates can be welded or soldered, as a result of which the soldered or welded seam simultaneously acts as a gasket as well.

In light of their manufacturing costs, weight and physicochemical properties, metallic heat exchanger plates are sometimes not advantageous.

### SUMMARY OF THE INVENTION

It is accordingly an object of the invention to provide a heat exchanger plate for a plate heat exchanger, a plate heat exchanger itself, as well as a method for manufacturing a heat exchanger plate, which overcome the hereinafore-mentioned disadvantages of the heretofore-known plates, heat exchangers and methods of this general type and in which a heat exchange can be realized in a particularly effective way at an especially high level of reliability and mechanical stability.

With the foregoing and other objects in view there is provided, in accordance with the invention, a heat exchanger plate for a plate heat exchanger. The heat exchanger plate comprises a plate substrate containing or formed of an SiC material or a silicon carbide material and having a front or upper side and a rear or bottom side. At least the front or upper side of the plate substrate is formed with a flow duct configuration having a plurality of flow ducts. Some or all of the flow ducts of the flow duct configuration are entirely or sectionally provided with duct webs bordering duct grooves and forming duct walls.

Therefore, one aspect of the present invention involves providing a ceramic material, and in particular an SiC material or silicon carbide material, as the material for the heat exchanger plate for a plate heat exchanger instead of a conventionally provided metallic material.

Another aspect of the present invention involves ensuring the mechanical stability of the heat exchanger plate given the selection of this type of material by having part or all of the provided flow ducts of the flow duct configuration partially or completely provided with duct webs, which form channel walls that completely or sectionally border duct grooves. These duct webs mechanically stabilize the flow ducts of the flow duct configuration, and hence the plate substrate as a whole, in particular in cases where they interact with other heat exchanger plates during use and when integrated in a plate heat exchanger, and allow a specific heat exchanger plate to abut against another directly adjacent heat exchanger plate in a substantially flat manner, so that the pressures exerted by the flowing media cannot lead to plate fractures in the underlying ceramic material.

Emphasis is placed on the following aspects that can be realized according to the invention:

The plate substrate, and hence the heat exchanger plate, can have any, i.e., even conventional, shapes and dimensions, so that in particular an overall height and overall width of the plate substrate, and hence of the heat exchanger plate according to the invention, are not limited.

With respect to flow ducts to be provided, a minimal duct depth can be provided in the heat exchanger plates according to the invention depending on the area of application, e.g., also within an approximately 0.2 mm range in so-called micro-heat exchangers or micro-recuperators.

When heat exchanger plates according to the invention are utilized in a plate heat exchanger, use can be made of a configuration with gaskets. However, this is not mandatory, since the reciprocal seal can also be established just by placing directly adjacent heat exchanger plates right on top of each other, wherein the heat exchanger plates support each other in the process, e.g., specifically in that the rear sides of plates consecutively touch the front sides of plates in the stack. Webs can also abut against webs, rear sides against webs, etc.

The geometric configuration of the heat exchanger plate according to the invention and its flow ducts in conjunction with the configuration of a plurality of heat exchanger plates according to the invention in a plate heat exchanger makes it possible to realize a diversion of the heat exchange media or fluids, e.g., also in terms of a plate heat exchanger with multiple passages and/or multiple diversions of the heat exchange fluid(s).

In accordance with another feature of the invention, a sintered silicon carbide material or SSiC material can be used in all or part of the plate substrate structure. The special advantage to this material selection lies in the added mechanical stabilization and increase chemical inertness.

In accordance with a further feature of the invention, a minimal layer thickness Dmin and/or an average layer thickness Dm of the plate substrate can range between about 2 mm and about 4 mm, in particular it can measure about 3 mm or less, preferably about 2 mm. The formed duct webs make it possible to correspondingly reduce the layer thicknesses of the heat exchanger plates, without any resultant mechanical destabilization. In the absence of the mechanical stabilization provided by the corresponding webs of the flow ducts, far higher layer thicknesses would be needed to stabilize the heat exchanger plates, provided the latter were fabricated out of ceramic materials. That would lead to a rise in weight and volume, thus necessitating larger equipment and higher costs at the same level of heat exchange.

In accordance with an added feature of the invention, the layer thickness Ds of the plate substrate can be greater in the area of a duct web than the minimum layer thickness Dmin of the plate substrate and/or the average layer thickness Dm of the plate substrate, thereby:

approximately satisfying the correlation Ds≧D min, or

approximately the correlation Ds≧Dm.

In accordance with an additional feature of the invention, a local width Bb of the floor of the duct groove of the flow duct and a local width Bsb of a base of the duct web of the flow duct at the height of the floor of the duct groove of the flow duct, each measured perpendicular to the local direction of the flow duct, can have a ratio Bb:Bsb of about 1:4, thereby approximately satisfying the correlation:

Bb:Bsb=10:4.

In accordance with yet another feature of the invention, the local width Bb of the floor of the duct grooves of the flow duct and a local width Bsp of a plateau of a duct web of a flow duct on the side facing away from the floor of the duct groove of the flow duct, each measured perpendicular to the local direction of the flow duct, can have a ratio Bb:Bsp within a range of about 10:3, thereby:

approximately satisfying a correlation 10:4≦Bb:Bsp≦10:2, or

preferably approximately a correlation Bb:Bsp=10:3.

In accordance with yet a further feature of the invention, the local width Bsb of the base of the duct web of the flow duct at the height of the floor of the duct groove of the flow duct and the local width Bsp of the plateau of the duct web of the flow duct on the side facing away from the floor of the duct groove of the flow duct, each measured perpendicular to the local direction of the flow duct, can have a ratio Bsb:Bsp ranging from about 1:1 to about 4:2, preferably of about 4:3, thereby:

approximately satisfying a correlation 4:2≦Bsb:Bsp≦1:1, or

preferably approximately a correlation Bsb:Bsp=4:3.

In accordance with yet an added feature of the invention, the channel walls of a flow duct include an angle α with the normal relative to the floor of the duct groove of the flow duct ranging from greater than 0° to less than 30°, preferably lying at about 15°, thereby:

approximately satisfying a correlation 0°<α≦30° or

preferably approximately a correlation α=15°.

In accordance with yet an additional feature of the invention, the local width Bb of the floor of the duct groove of the flow duct, measured perpendicular to the local direction of the flow duct, and a depth t of the duct groove of the flow duct, measured perpendicular to the floor of the duct groove of the flow duct, can have a ratio Bb:t ranging from about 10:10 to about 10:4, preferably of about 10:4, thereby:

approximately satisfying a correlation 10:10≦Bb:t≦10:4, or

preferably approximately a correlation Bb:t=10:4.

The measures just described are realized by various geometric configurations during the configuration of the heat exchanger plate according to the invention with regard to the duct geometry in relation to the plate thickness, as a result of which especially favorable mechanical properties are achieved at a comparatively low volume and/or weight.

In accordance with again another feature of the invention, supply or removal openings that penetrate the plate substrate from the upper side to the bottom side and supply or remove a first heat exchange fluid F1 to or from the upper side of the plate substrate can be provided, wherein the flow duct configuration is constructed to transport the first heat exchange fluid F1 from the supply opening to the removal opening.

In accordance with again a further feature of the invention, all or sections of the flow ducts in the flow duct configuration can have a multi-undulating progression. The undulating direction U can run in a surface or plane defined by the plate substrate and/or perpendicular to a flowing direction defined by the respective flow duct locally and/or on average.

In accordance with again an added feature of the invention, the shape of the undulation for a respective flow duct can be a shape selected from a group of shapes that includes sawtooth shapes, alternating echelon or stepped shapes, wave shapes, sinus shapes and combinations thereof.

In accordance with again an additional feature of the invention, the rear or bottom side of the plate substrate can have a second flow duct configuration for a second heat exchange fluid F2 with a plurality of corresponding flow ducts.

In accordance with still another feature of the invention, second supply and removal openings that penetrate the plate substrate from the upper side to the bottom side can be provided to supply or remove the second heat exchange fluid F2 to or from the rear or bottom side of the plate substrate, wherein the second flow duct configuration is constructed to transport the second heat exchange fluid F2 from the second supply opening to the second removal opening.

In accordance with still a further feature of the invention, the heat exchanger plate can be constructed to be rotationally symmetrical by 180° with respect to the front or upper side and rear or bottom side in relation to a symmetry axis S running in the plate substrate.

In accordance with still an added feature of the invention, the plate substrate can have a substantially rectangular shape. In this case the supply and removal openings can be formed in the area of opposing first, preferably shorter, sides of the rectangular shape, in particular in the corner areas. The directions in which the first and/or second heat exchange fluids F1, F2 flow and/or the primary directions in which the flow ducts extend, can be substantially formed along the directions in which opposing second, preferably longer, sides of the rectangular shape extend.

The measures described above make it possible to realize different flow geometries when a plurality of heat exchanger plates according to the invention interact, i.e., are rowed together in stacks or packets.

With the objects of the invention in view, there is also provided a plate heat exchanger, comprising a plurality of adjacent heat exchanger plates according to the invention constructed and disposed to precede and follow one another in a sequence, the rear or bottom side of the plate substrate of a respective preceding heat exchanger plate lying directly opposite or directly abutting against the front or upper side of the plate substrate of a respective directly following heat exchanger plate or with a sealing configuration therebetween, at least one of the sequence of the heat exchanger plates or a formation of the sealing configuration directly forming sequential through-flow spaces separated from each other in terms of flow, directly adjacent through-flow spaces being separated in pairs in terms of flow, and respective alternating adjacent through-flow spaces joined together in pairs in terms of flow each being allocated to a respective heat exchange fluid and configured to allow the respectively allocated heat exchange fluid to flow from the respective supply opening to the respective removal opening.

Therefore, another aspect of the present invention provides for a plate heat exchanger with a plurality of n heat exchanger plates according to the invention, wherein the heat exchanger plates are constructed and disposed in such a way that the rear or bottom side of the plate substrate of a respective preceding heat exchanger plate j=1, . . . , n−1 lies directly opposite the front or upper side of the plate substrate of a respective directly ensuing heat exchanger plate j+1 with j=1, . . . , n−1 or abuts against the latter directly, or in particular with a sealing configuration interspersed, that the sequence of heat exchanger plates j=1, . . . , n and/or, in particular, the creation of the sealing configuration cause directly sequential through-flow spaces R1, . . . , Rn+1 separated from each other in terms of flow to form or be formed, that directly adjacent through-flow spaces Rj, Rj+1, j=1, . . . , n are separated in pairs in terms of flow, and that respective adjacent alternating or next but one through-flow spaces Rj, Rj+2, j=1, . . . , n−1 are joined together in pairs in terms of flow, are each allocated to a heat exchange fluid F1, F2 and are constructed to allow respectively allocated heat exchange fluids F1, F2 to flow from the respective supply opening to the respective removal opening.

With the objects of the invention in view, there is furthermore provided a method of manufacturing a heat exchanger plate for a plate heat exchanger. The method comprises the steps of providing or forming a plate substrate that contains or is formed of a ceramic, SiC material or a silicon carbide material with a front or upper side and a rear or bottom side, forming a flow duct configuration with a plurality of flow ducts on the front or upper side of the plate substrate, and fabricating some or all of the flow ducts of the flow duct configuration entirely or sectionally with duct webs that border duct grooves and form duct walls.

In accordance with another mode of the invention, the plate substrate can contain or be formed of a sintered silicon carbide material or SSiC material.

In accordance with a concomitant mode of the invention, flow ducts of the flow duct configuration can be constructed to exhibit a completely or sectionally multi-undulating progression. An undulating direction can be configured to run in a surface or plane defined by the plate substrate and/or perpendicular to a flowing direction defined by the flow duct locally or on average. A shape of an undulation can be a shape selected from a group of shapes that includes sawtooth shapes, alternating echelon or stepped shapes, wave shapes, sinus shapes and combinations thereof.

Other features which are considered as characteristic for the invention are set forth in the appended claims.

Although the invention is illustrated and described herein as embodied in a heat exchanger plate, a plate heat exchanger provided therewith and a method for manufacturing a heat exchanger plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a diagrammatic, top-plan view depicting a front side of an embodiment of a heat exchanger plate according to the invention;

FIG. 1B is a top-plan view depicting a rear side of the embodiment of the heat exchanger plate according to the invention shown in FIG. 1;

FIGS. 2A and 2B are top-plan views illustrating another embodiment of the heat exchanger plate according to the invention which is analogous to FIGS. 1 and 2, in which primary flow ducts have a different geometry;

FIGS. 3 and 4 are top-plan views depicting the front side of two embodiments of heat exchanger plates according to the invention, which are constructed similarly to those in FIGS. 1A and 2A, but in which duct webs of supply ducts exhibit a different geometry relative thereto;

FIGS. 5 and 6 are cross-sectional views depicting heat exchanger plates according to the invention to illustrate cross sections of duct geometries;

FIG. 7 is an exploded, perspective view depicting a stack of heat exchanger plates according to the invention, of the kind that can be provided in a plate heat exchanger;

FIGS. 8A-8D are side-elevational views depicting stacks or packets of heat exchanger plates shown in FIG. 7, in which flow conditions for two provided flow media are illustrated;

FIG. 9 is a side-elevational view depicting an embodiment of a plate heat exchanger according to the invention, which exhibits a stack or packet of heat exchanger plates according to the invention; and

FIGS. 10 and 10A are top-plan and cross-sectional views diagrammatically depicting another embodiment of a heat exchanger plate according to the invention.

### DETAILED DESCRIPTION OF THE INVENTION

Referring now to the figures of the drawing, with which embodiments of the present invention will be described below, it is noted that all embodiments of the invention along with their technical features and properties can be combined in isolation from each other or randomly compiled as desired and without limitation.

Structurally and/or functionally identical, similar or equally acting features or elements are marked with the same reference numbers below in conjunction with the figures. A detailed description of these features or elements is not repeated in each case.

Reference will first be made to the drawings in general.

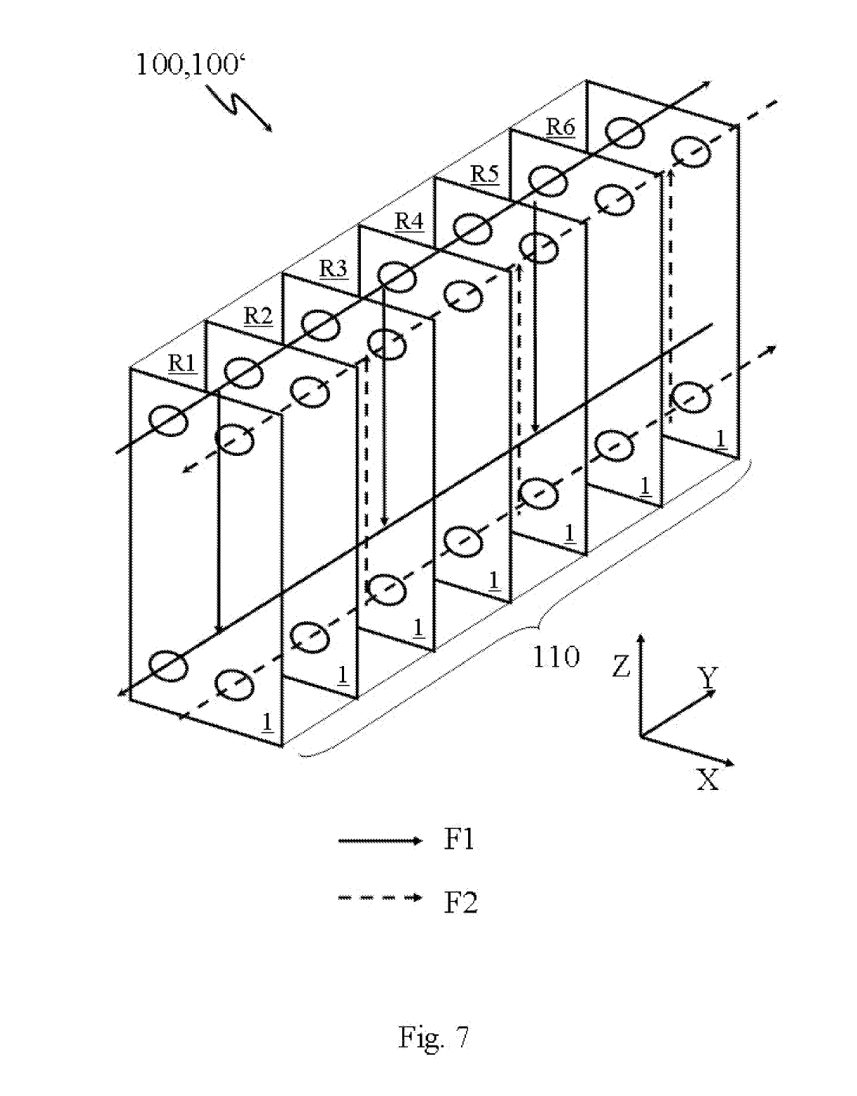

The present invention also relates, in particular, to a plate heat exchanger 100 or a plate recuperator 100 seen in FIGS. 7-10, with a plurality of heat exchanger plates 1 according to the invention.

In particular, monolithically constructed, ceramic materials are provided in this case for configuring the heat exchanger plates 1 according to the invention.

Monolithic, ceramic materials are highly sensitive to flexural loads. That is why their use in configuring heat exchanger plates 1 in plate heat exchangers 100 has previously been largely ruled out, since various construction concepts for flow chambers in ceramic heat exchanger plates and, in particular, in SSiC heat exchanger plates 1, offer no support over large areas of the heat exchanger plates 1. That has previously resulted in plate fractures due to flexural loads caused by the interior pressure loads during exposure of the respective flow chambers to liquid pressure.

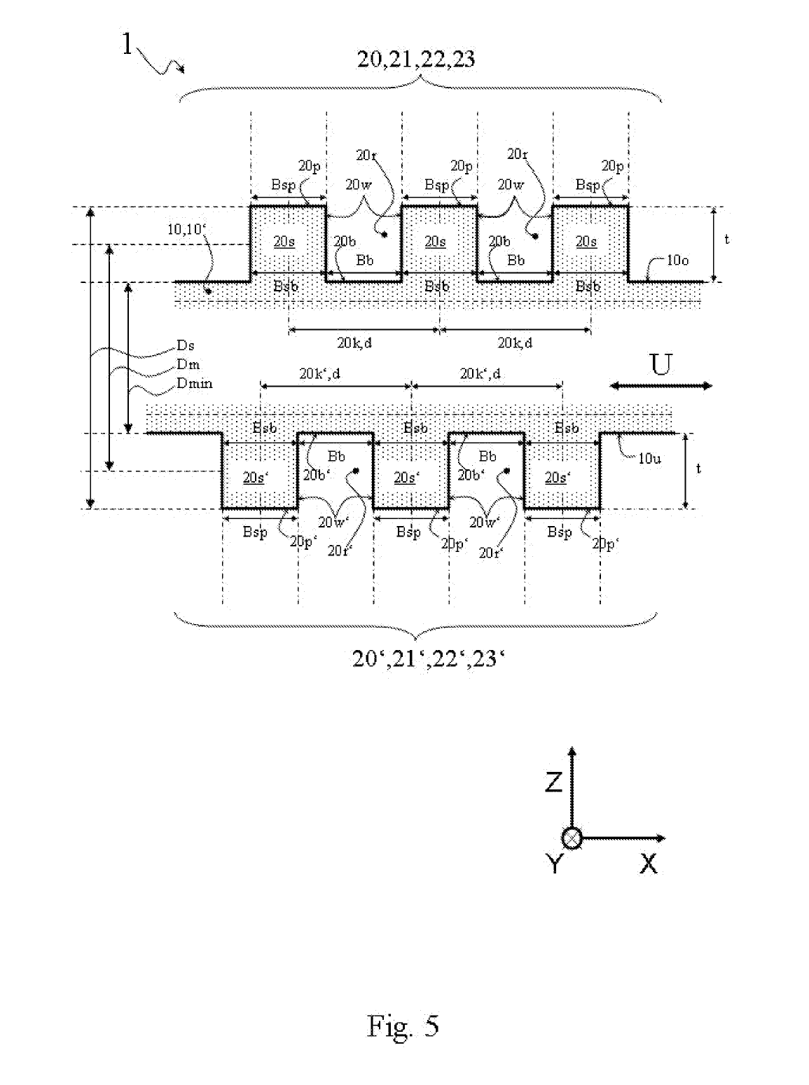

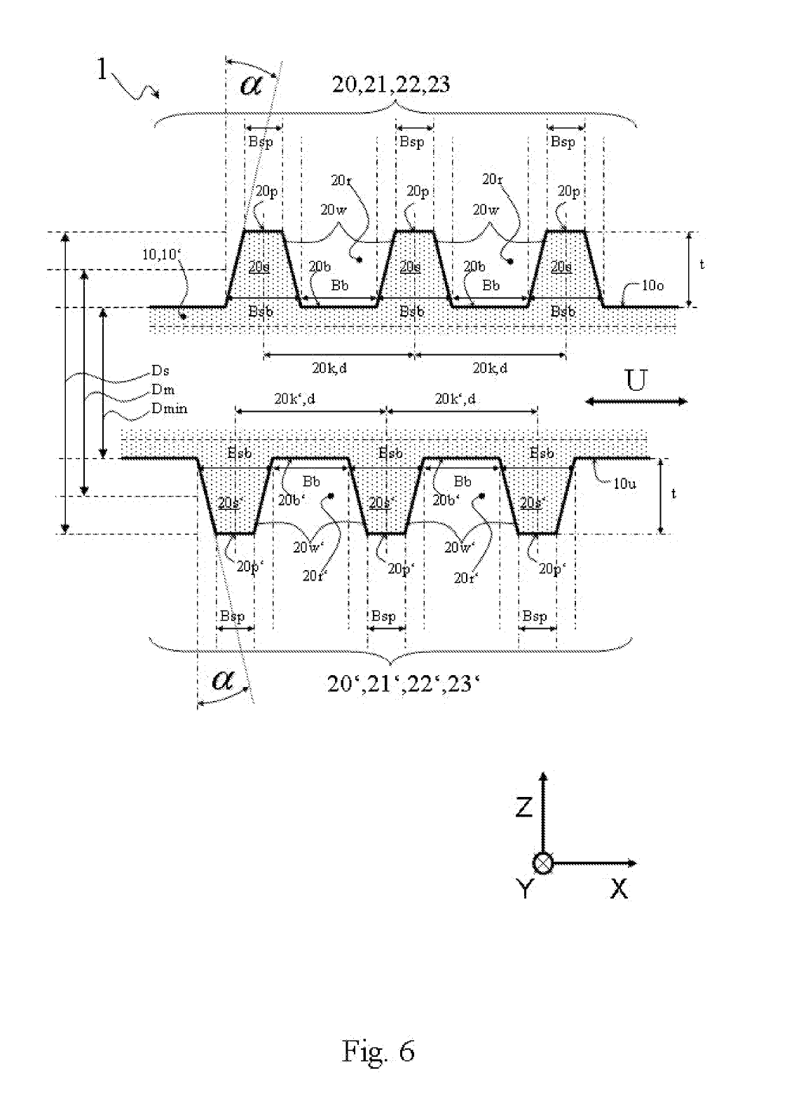

That effect is countered according to the invention by constructing flow ducts 20k with so-called duct webs 20s, which form duct walls 20w seen in FIGS. 5 and 6 that for their part completely or sectionally border duct grooves 20r of the flow ducts 20k of a flow duct configuration 20.

It is precisely the duct webs 20s that inherently stabilize the structure of the heat exchanger plate 1 composed of a ceramic material, and especially of an SiC or SSiC material, in particular by virtue of the fact that they help support a configuration of a plurality of heat exchanger plates 1 according to the invention relative to each other in a plate heat exchanger 100.

Detailed reference will now be made to the drawings.

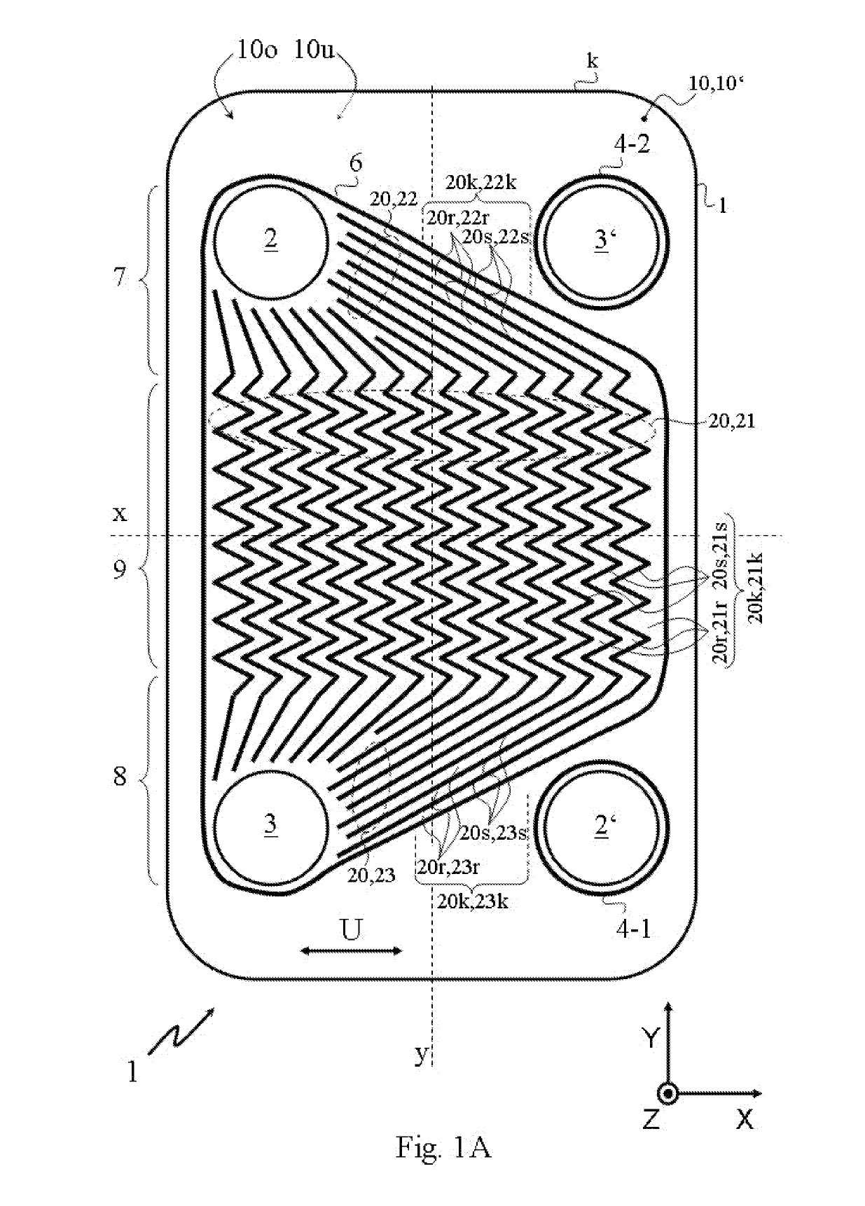

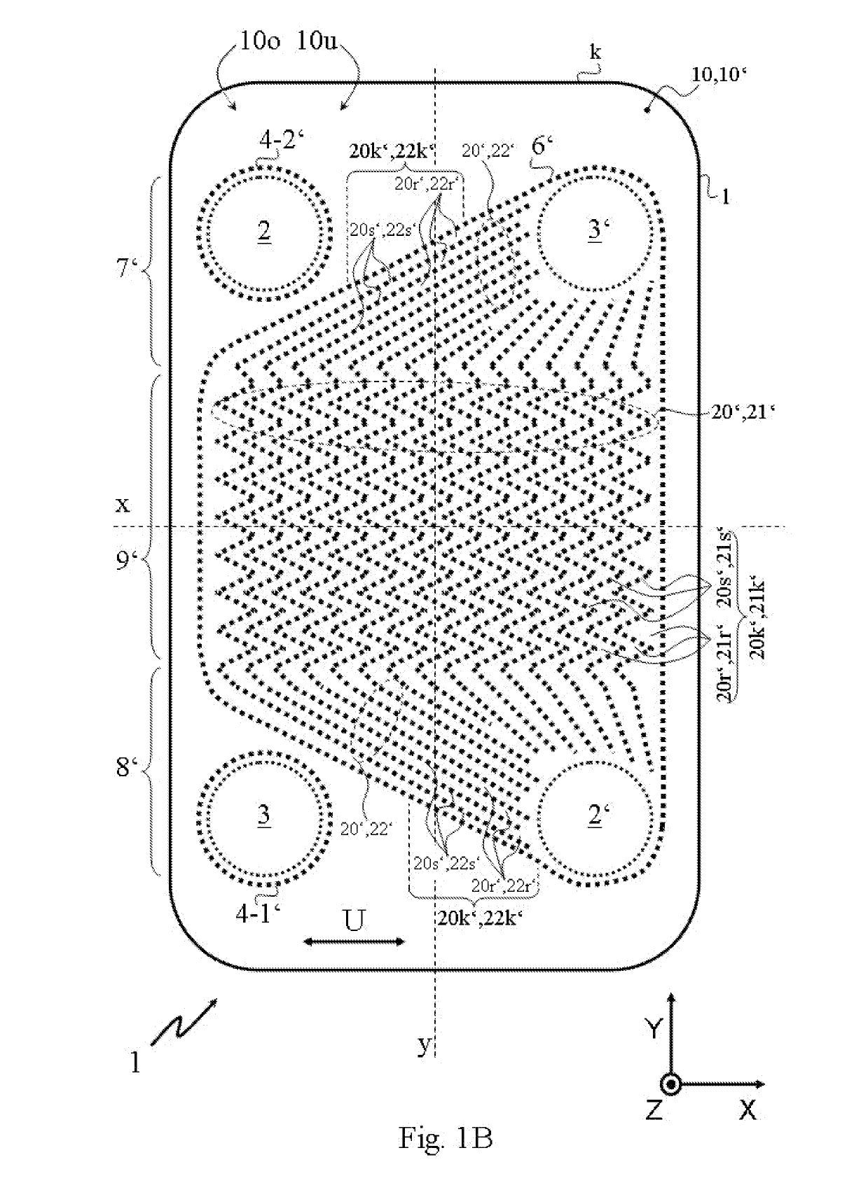

FIG. 1 presents a diagrammatic top view of a first embodiment of the heat exchanger plate 1 or heat recuperator 1 plate.

The plate 1 is substantially formed of a plate substrate 10, which is also referred to simply as a substrate 10 for the heat exchanger plate 1, and contains or is formed of at least one ceramic material 10′, preferably an SiC material or silicon carbide material 10′, and further preferably contains or is formed of at least one sintered silicon carbide material 10′ or SSiC material 10′.

The substrate 10 for the heat exchanger plate 1 has a plate structure with a front side or upper side 10o and a rear side or bottom side 10u. However, these sides can in particular be on an equal footing, precisely with respect to a respective application, and can also be similarly or even identically structured.

The so-called front side or upper side 10o of the substrate of the heat exchanger plate 1 according to the invention will first be described below.

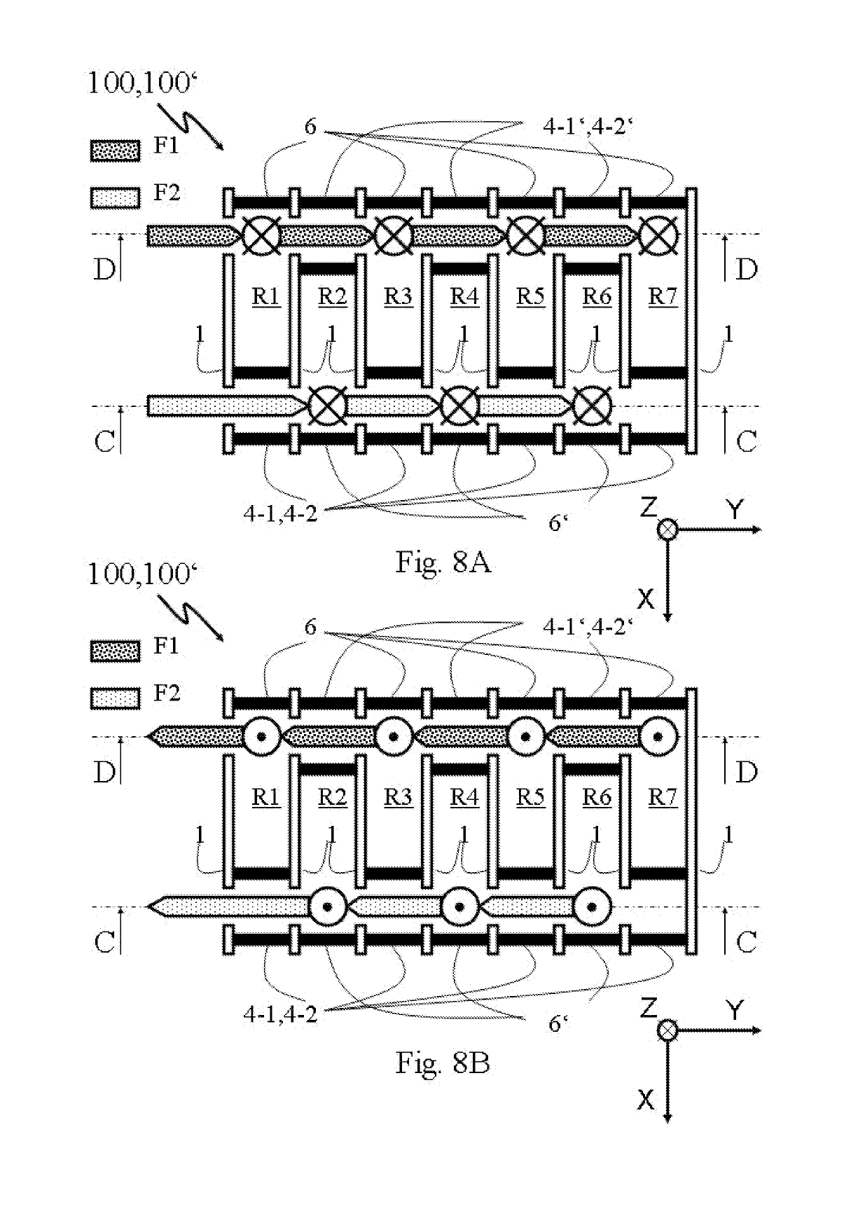

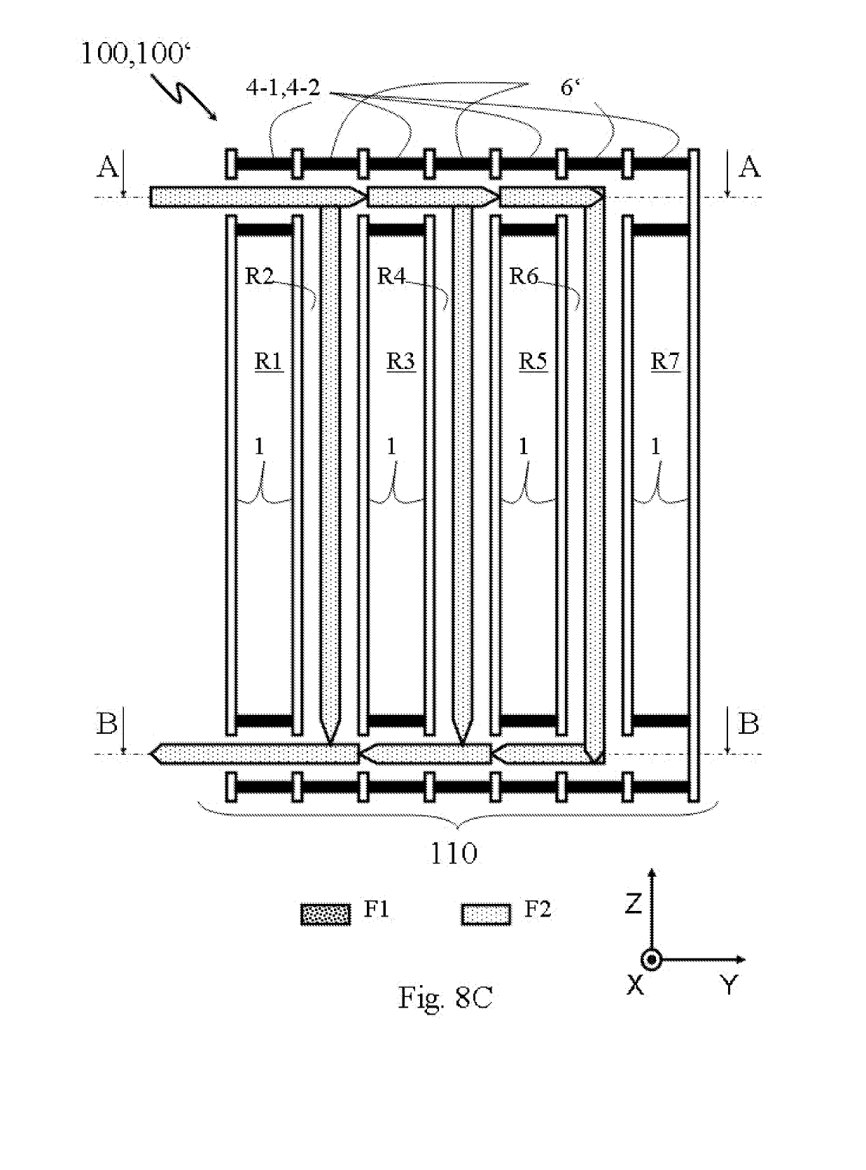

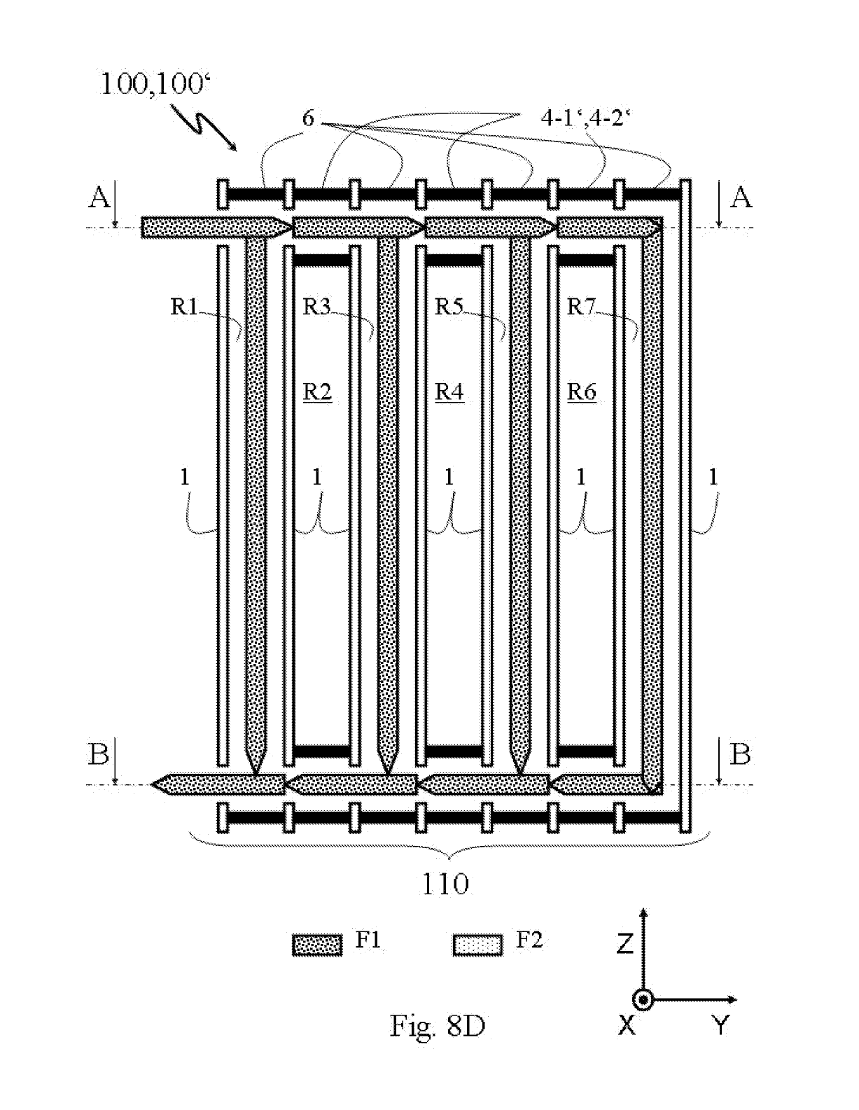

Initially, a supply opening 2 for a first fluid F1 indicated in FIGS. 7-8D, a removal opening 3 for the first fluid F1, a supply opening 2′ for a second fluid F2 as well as a removal opening 3′ for the second fluid F2 are provided. All of the openings 2, 2′, 3, 3′ are formed at the edge or corner regions of the plate substrate 10.

The supply opening 2 for the first fluid F1 is formed in the upper left corner in the view shown in FIG. 1A. The removal opening 3 for the first fluid F1 is formed in the lower left corner. However, the removal opening 3 for the first fluid F1 can be situated diagonally opposite the supply opening 2 for the first fluid F1, i.e., in the lower right corner in the view presented in FIG. 1A.

In the embodiment in FIG. 1A, the supply opening 2′ for the second fluid F2 is formed in the area of the lower right corner, while the removal opening 3′ for the second fluid F2 is formed in the area of the upper right corner. However, the removal opening 3′ for the second fluid can also be situated diagonally opposite the supply opening 2′ for the second fluid, i.e., in the area of the upper left corner in the view depicted in FIG. 1A.

The respective supply openings and removal openings for a respective fluid each lie opposite each other in relation to the longitudinal alignment of the plate substrate 10. In the configuration shown in FIG. 1A, they are additionally both disposed on the respective left side or right side of the plate substrate 10 in relation to a short edge k. In addition, the two supply openings 2, 2′ on one hand and the two removal openings 3, 3′ on the other hand lie opposite each other in relation to a longitudinal edge I or long edge I of the plate substrate 10, so that a countercurrent process is realized, in particular, when combining a plurality of heat exchanger plates 10 according to the invention in a plate heat exchanger 100. This will be elucidated in even more detail below.

The supply opening 2 and the removal opening 3 for the first fluid are encompassed or bordered on the upper side 10o of the plate substrate 10 by a primary gasket 6 for the front side 10o and for the first fluid F1, so that the supply opening 2′ and removal opening 3′ for the second fluid F2 lie outside the primary gasket 6 for the upper side 10o.

In addition to the supply opening 2 and removal opening 3 for the first fluid F1, the configuration 20 of flow ducts 20k, which is also referred to as a duct configuration 20 or flow duct configuration 20, is provided inside the primary gasket 6 for the front side 10o. The plurality of flow ducts 20k provided in this duct or channel configuration 20 extends on the surface or upper side 10o of the substrate 10, specifically in that a plurality of the individual ducts 20k form a kind of relief on the upper side 10o of the plate substrate 10 inside the primary gasket 6 for the upper side 10o. The ducts 20k substantially extend between the supply opening 2 and removal opening 3 for the first fluid F1.

The entire duct configuration 20 is divided into a primary duct configuration or primary heat exchange duct configuration 21, which is located in the middle between the supply opening 2 and removal opening 3 for the first fluid and spaced a little apart from the latter, and is formed by primary ducts 21k or primary heat exchange ducts 21k. A supply or distribution duct configuration 22 with supply ducts 22k or distribution ducts 22k or a bundling, merging or removal duct configuration 23 with a plurality of bundling, merging or removal ducts 23k is directly adjacent the supply opening 2 and removal opening 3 for the first fluid F1 and directly connected with and/or adjacent the primary duct configuration 21.

During operation, the first fluid F1 is supplied through the supply opening 2, and introduced on the upper side 10o of the plate substrate in a practical manner and distributed there. The distribution is handled by the distribution ducts 22k of the supply and distribution duct configuration 22 that adjoin the supply opening 2 for the first fluid F1.

The distribution ducts 22k of the supply and distribution duct configuration 22 carry the first fluid F1 over into the primary ducts 21k or primary heat exchange ducts 21k of the primary duct configuration 21 or primary heat exchange duct configuration 21. The primary ducts 21k and primary duct configuration 21 are comparatively longer in structure than the supply and distribution duct configuration 22, resulting in a longer retention time there for the first fluid F1 streaming in the ducts 20k, so that a strong heat transfer to the plate substrate 10 comes about.

The primary ducts 21k then transition into the so-called bundling ducts 23k, which can also be referred to as removal ducts 23k or merging ducts 23k, and which accommodate the first fluid F1 from the primary ducts 21k and route it to the removal opening 3 for the first fluid F1, through which the first fluid F1 then once again exits the duct configuration 20, and thus the upper side 10o of the substrate of the heat exchanger plate 1 according to the invention, after streaming through the ducts 20k of the entire duct configuration 20, starting from the supply opening 2 for the first fluid F1.

Due to the primary gasket 6 for the first fluid F1 and for the upper side 10o, the first fluid F1 does not reach the outer region outside of the primary gasket 6, and hence the regions of the supply opening 2′ and removal opening 3′ for the second fluid F2, while flowing from the supply opening 2 to the removal opening 3. In addition, the supply opening 2′ and removal opening 3′ for the second fluid have first and second secondary gaskets 4-1 or 4-2, which once again seal off the supply opening 2′ or removal opening 3′ for the second fluid F2 by outwardly enveloping the supply opening 2′ and removal opening 3′ for the second fluid F2 in its edge region. As a consequence, the supply opening 2 and removal opening 3 for the first fluid F1 and the supply opening 2′ and removal opening 3′ for the second fluid F2 are separated or isolated from each other overall in terms of flow, so that the first and second fluids F1 or F2 do not mix together on the upper side 10o of the plate substrate.

The supply opening 2 for the first fluid F1 and the supply and distribution duct configuration 22 with the distribution ducts 22k or supply ducts 22k together form a supply or distribution region 7 for the front side 10o of the substrate or for the first fluid F1.

The primary duct configuration 21 or primary heat exchange duct configuration 21 with its primary ducts 21k or primary heat exchange ducts 21k forms a primary heat exchange region or primary heat transfer region 9 on the upper side 10o of the plate substrate 10 for the first fluid F1 of the heat exchanger plate 1 according to the invention.

Accordingly, the removal opening 3 for the first fluid F1 and the bundling and removal duct configuration with their bundling ducts 23k, merging ducts 23k or removal ducts 23k form a so-called bundling and removal region 8 for the front side 10o of the plate substrate 10 of the heat exchanger plate 1 according to the invention for the first fluid.

The configuration shown in a top view in FIG. 1A is strictly axially symmetrical in relation to an illustrated symmetry axis x. With respect to the also illustrated symmetry axis y, at least the supply opening 2 for the first fluid F1 and the removal opening 3′ for the second fluid F2 on one hand and the removal opening 3 for the first fluid F1 and the supply opening 2′ for the second fluid F2 are disposed in a strictly axially symmetrical manner. The outer shape of the substrate 10 is configured in a strictly axially symmetrical manner in relation to both axes x and y, and is substantially shaped like an elongated rectangle with rounded corners, and a height-width ratio for the long edge I and short edge k within a range of about 2:1.

In the configuration depicted in FIG. 1A, the supply ducts 22k or distribution ducts 22k transition directly into the primary ducts 21k in a 1-to-1 configuration or allocation, and the latter in turn transition into the bundling ducts 23k or removal ducts 23k in a 1-to-1 configuration. The hollow duct spaces 20r or duct grooves 20r are depicted in the figure as white or bright, while the duct webs 20s including the duct walls are shown as black or dark.

Therefore, the ducts 20k as a whole in the configuration in FIG. 1A are formed by a respective supply duct 22k, a directly allocated primary duct 21k and a removal duct 23k directly allocated thereto. The primary ducts 21k in this case are shaped like a sawtooth or zigzag line with a triangular basic pattern. However, other embodiments are also conceivable.

The crucial factor with respect to the configuration of FIG. 1A is that the duct configuration 20 as a whole and the ducts 20k, in particular, are formed of so-called duct webs 20s, which form the duct walls 20w of the duct groove 20r. These duct webs 20s yield a special mechanical stability, precisely from a hydrodynamic or fluidodynamic standpoint in the area of the supply openings 2 for the first fluid F1.

On one hand, the mechanical stability of the inherently flatly constructed plate substrate 10 is inherently stabilized by the recessed sequence of the groove 20r and web 20s. However, the interaction between a plurality of plate substrates 10 of stacked heat exchanger plates 1 according to the invention in a plate heat exchanger 100 additionally has an effect in which directly adjacent substrates 10 are mutually supported in the areas of the duct webs 20s. This double mechanical stabilization or reinforcement makes it possible to use the ceramic substrate material 10′ of the plate substrate 10 that is inherently not able to withstand strong loads in terms of flexural stress according to the invention, in particular in the form of so-called silicon carbide materials or SiC materials, and in particular in the form of sintered silicon carbide materials or SSiC materials, without it being necessary to increase the plate thickness or layer thickness DS of the plate substrate 10 of the heat exchanger plate 1 according to the invention, since the web structure, i.e., the recessed sequence of the grooves 20r of the ducts and the webs 20s of the ducts 20k, along with the reciprocal support by abutting the webs 20s of the ducts 20k directly in the plate stack of adjacent heat exchanger plates 1 yields a higher stiffness and stabilization relative to each other, so that the flexural stress on the plate substrate 10 of the heat exchanger plate 1 according to the invention does not exceed the possible maximum, even when the first fluid F1 is introduced through the supply opening 2 for the first fluid F1 at the accompanying high pressures.

As viewed from the direction of the upper side 10o of the substrate 10 of the configuration in FIG. 1A, FIG. 1B presents a kind of phantom view showing the structure of the rear side 10u or bottom side 10u of the same substrate 10. For this reason, all structures are depicted with dots or dashes.

The configuration of the primary gasket 6′ provided in this case for the second fluid F2 for the rear side 10u as well as of the first and second secondary gaskets 4-1′ and 4-2′ for the supply opening 2 or for the removal opening 3 for the first fluid F1 in relation to the rear side 10u, is strictly axially or mirror symmetrical to the symmetry axis x, and by comparison to the corresponding configuration shown in FIG. 1A in relation to the primary gasket 6 for the first fluid F1 and the secondary gaskets 4-1 and 4-2 for the second fluid in relation to the front side 10o is strictly axially or mirror symmetrical to the symmetry axis y.

The primary gasket 6′ in this case envelops the supply opening 2′ and the removal opening 3′ for the second fluid F2, outwardly separates the supply opening 2 and removal opening 3 for the first fluid F1 in terms of flow with the corresponding first and second secondary gaskets 4-1′ and 4-2′, and its interior has the duct configuration 20′ or flow duct configuration 20′ for the second fluid F2 on the rear side 10u of the plate substrate 10 of the heat exchanger plate 1 according to the invention.

As a consequence, the configuration for the rear side 10u or bottom side 10u of the plate substrate 10 substantially corresponds to that for the front side 100 of the plate substrate 10, which is depicted in FIG. 1A.

Accordingly, a supply area 7′ or distribution area 7′, a bundling area 8′ or removal area 8′, and a primary heat exchange area 9′ or primary heat transfer area 9′ between them are formed for the rear side 10u or second fluid F2, specifically through the interaction of the supply opening 2′ for the second fluid F2 and the supply duct configuration 22′ or distribution duct configuration 22′ with the supply ducts 22k′ or distribution ducts 22k′ for the second fluid F2, through the primary duct configuration 21′ or primary heat exchange duct configuration 21′ with the primary ducts 21k′ or primary heat exchange ducts 21k′ for the second fluid F2, or through the interaction of the removal opening 3′ for the second fluid F2 with the bundling duct configuration 23′, merging duct configuration 22′ or removal duct configuration 24′ with the bundling, merging or removal ducts 23k′ for the second fluid F2 on the rear side 10u of the plate substrate 10 of the heat exchanger plate 1 according to the invention.

Otherwise, that which was stated for the front side 10o according to FIG. 1A applies accordingly.

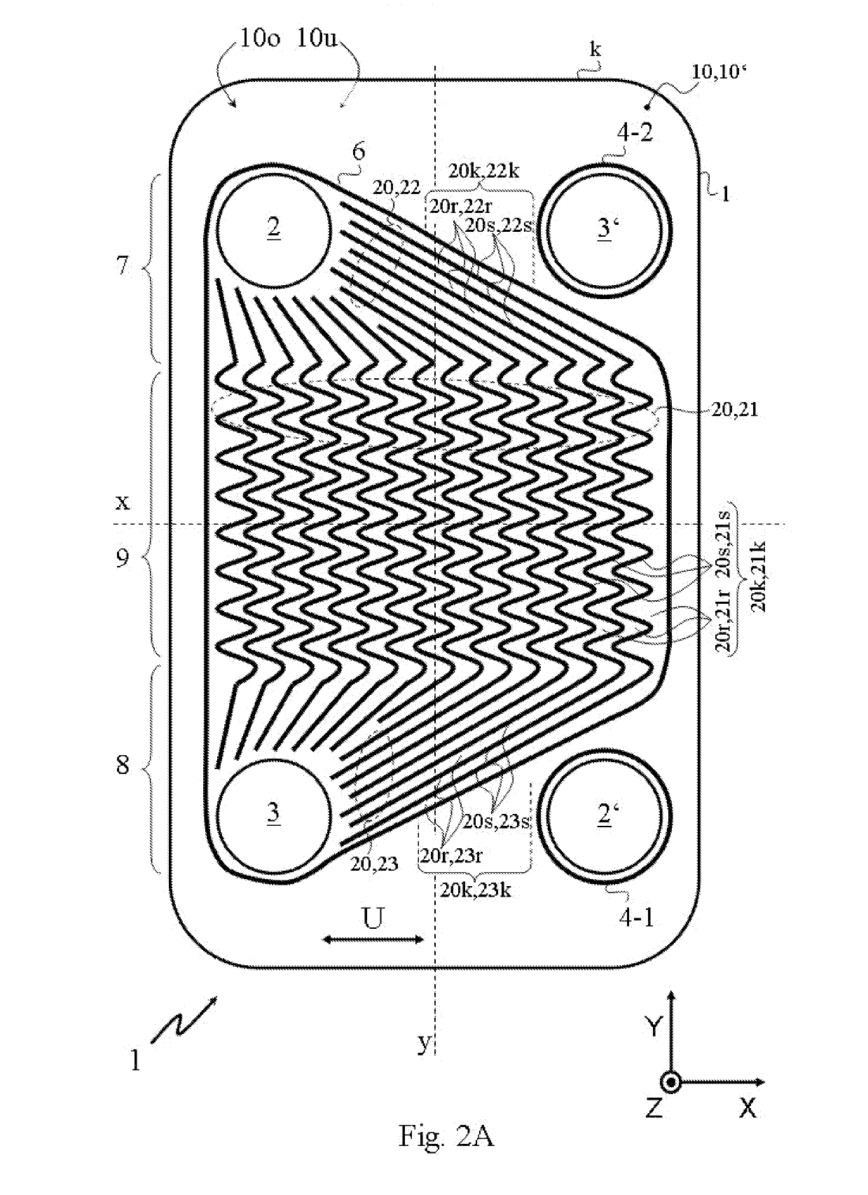

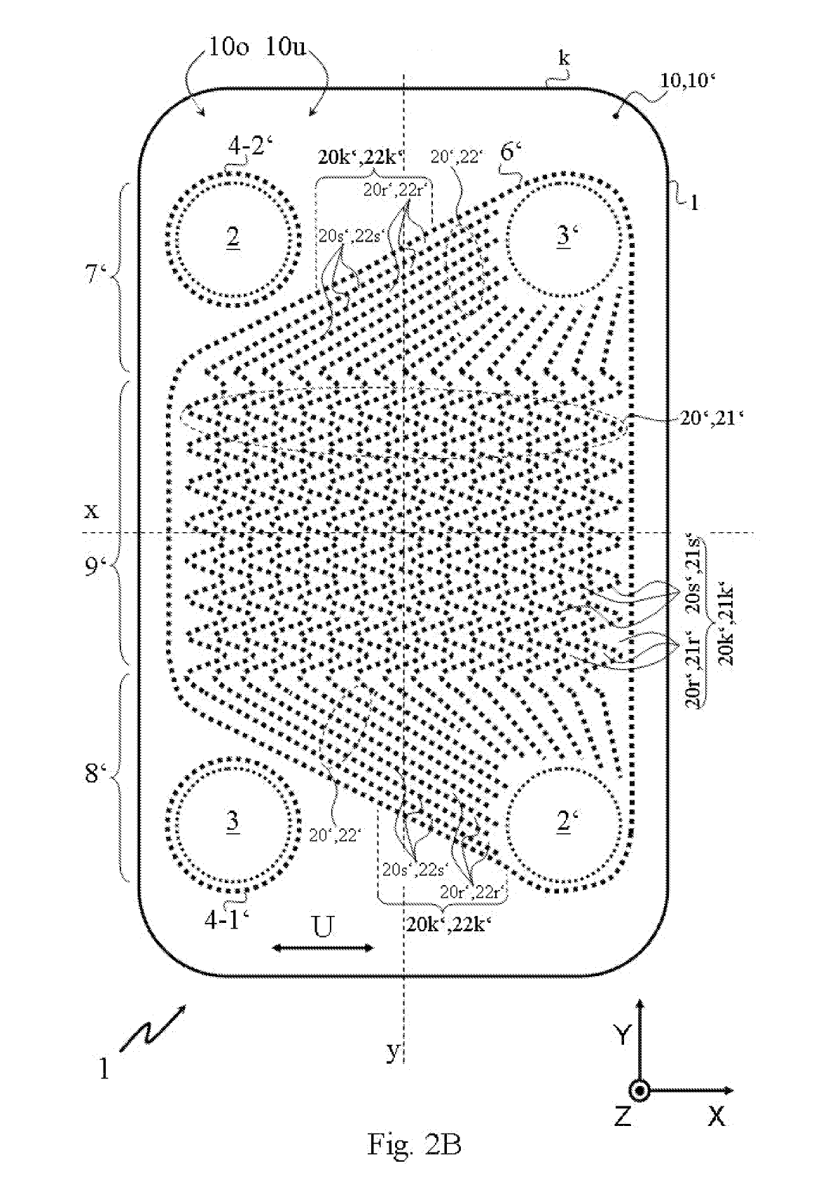

The configurations shown in FIGS. 2A and 2B correspond to those in FIGS. 1A and 1B, except that the primary ducts 21k for the first fluid F1 and 21k′ for the second fluid F2 and the corresponding webs 20s, 20s′ in FIGS. 1A and 1B have a sawtooth or zigzag shape, while a wave shape is present in the embodiment according to FIGS. 2A and 2B, in particular a type of sinusoidal progression.

All duct shapes are basically conceivable, i.e., for example with any lateral undulation, i.e., running in the plane of the upper side 10o or bottom side 10u of the substrate 10, with an undulating direction U in the XY plane of the front side 10o and/or the rear side 10u of the plate substrate 10 of the heat exchanger plate 1 according to the invention.

The undulation itself results in a longer retention time of the fluid F1, F2 flowing or streaming in the duct 20k, 20k′, and hence in a more intimate exchange of heat with the material 10′ of the substrate 10.

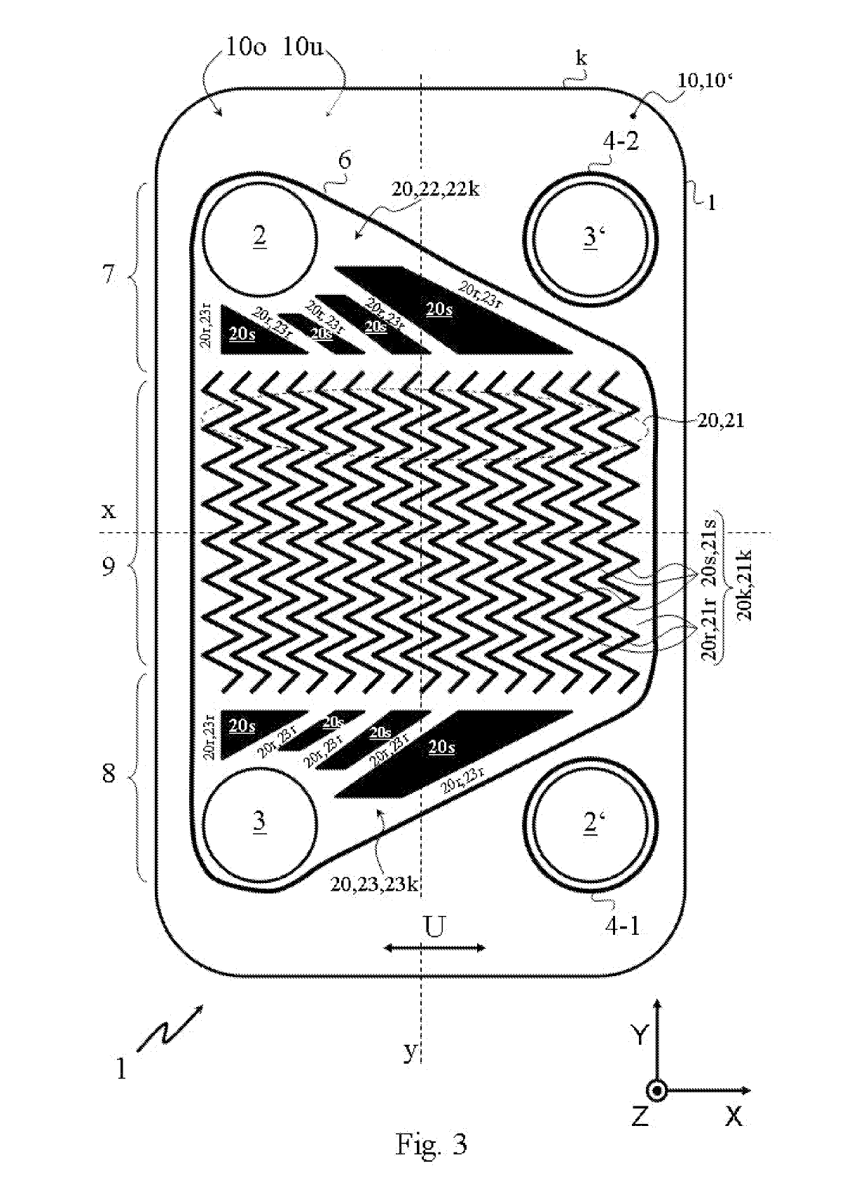

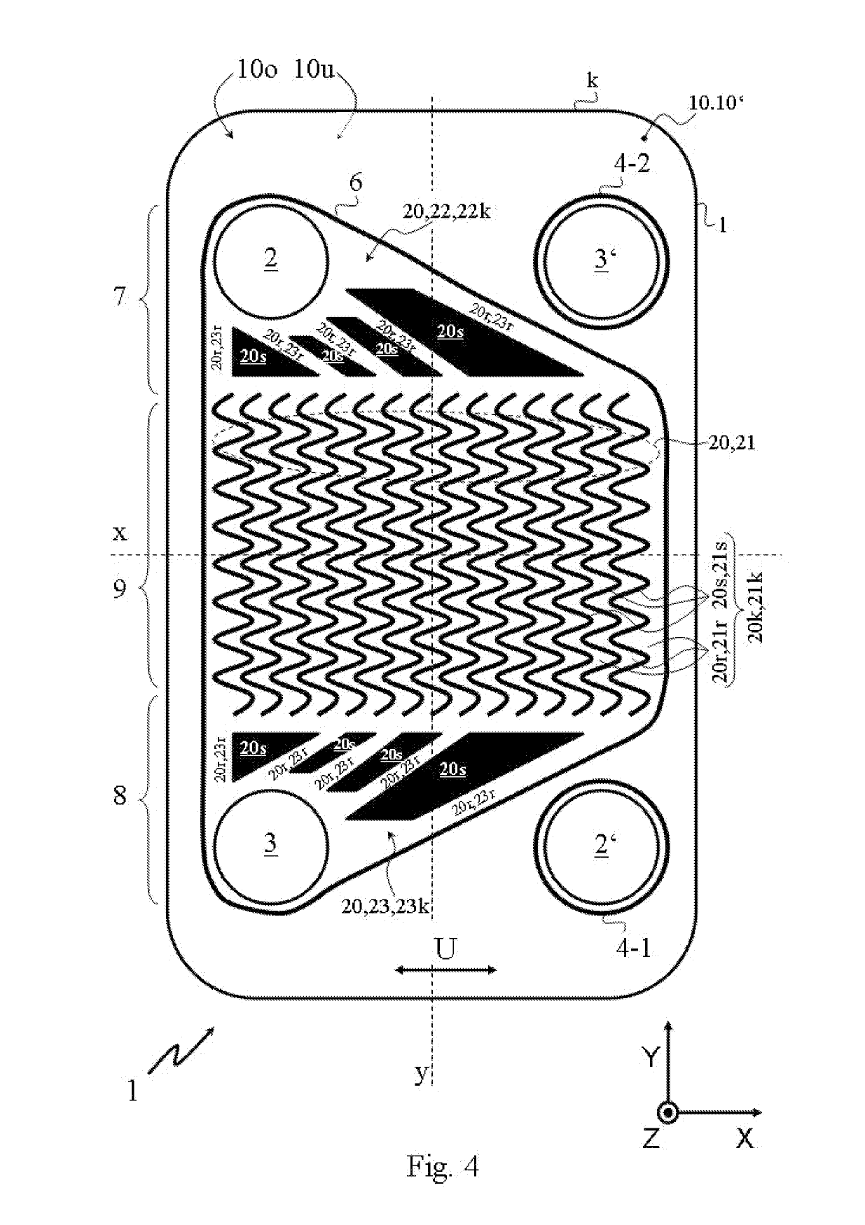

FIGS. 3 and 4 present top views depicting the upper sides 10o of substrates 10 for two other embodiments of the heat exchanger plate 1 according to the invention. In terms of their structure, the primary ducts 21k, 21k′ of the flow ducts 20k, 20k′ in this case substantially correspond to the ducts in the configurations in FIGS. 1A and 1B on one hand and FIGS. 2A and 2B on the other hand, i.e., they exhibit a sawtooth or wave shape.

As opposed to the configurations in FIGS. 1A to 2B, the configurations in FIGS. 3 and 4 exhibit supply ducts 22k, 22k′ and removal ducts 23k, 23k′, which are no longer in a 1-to-1 correspondence with the primary ducts 21k, 21k′. Rather, the duct webs 20s, 20s′, in particular 22s, 22s′, 23s, 23s′, are in this case greatly extended in structure, so that the overall number of supply ducts 22k, 22k′ and removal ducts is lower than the number of primary ducts 21k, 21k′. However, given the extension of webs 20s, 20s′, 22s, 22s′, 23s, 23s′, the mechanical stability in this case is further increased in the area of the supply opening 2 and removal opening 3 for the first medium, and correspondingly for the supply opening 2′ and 3′ for the second medium on the rear side 10u.

FIGS. 5 and 6 present fragmentary, partial views through a substrate 10 of two embodiments of the heat exchanger plate 1 according to the invention, specifically as viewed in a direction Y taking the configurations in FIGS. 1A to 4 as the basis.

The configuration shown in FIGS. 5 and 6 reveals the various possible embodiments for the cross section of ducts 20k, 20k′, in particular the primary heat exchange duct configuration 21, 21′, i.e., primary ducts 21k, 21k′.

In the configuration depicted in FIG. 5, the respective duct grooves 20r, 20r′ and respective duct webs 20s, 20s′ of the respective duct 20k, 20k′ have approximately a rectangular or quadratic shape, and exhibit substantially the same configuration relative to each other. For example, a respective duct floor or base 20b, 20b′ in this case forms a level of minimum layer thickness Dmin for the underlying substrate 10. The webs or duct webs 20s, 20s′ are placed thereupon with a height that forms a depth t of the duct groove 20r, 20r′, which corresponds to a width Bb of the floor 20b, 20b′ of the duct groove 20r of the flow duct 20k, 20k′, but also to a width Bsb of the duct web 20s, 20s′ at the height of the floor 20b, 20b′, and also a local width Bsp of a plateau 20p, 20p′ of the web 20s, 20s′.

The geometry of the ducts 20k, 20k′ gives the duct walls 20w, 20w′ a perpendicular structure. An identical width is selected for the base of the respective duct web 20s, 20s′ and the plateau 20p, 20p′ of the duct web 20s, 20s′, wherein Bsp=Bsb.

By contrast, the base of the duct web 20s, 20s′ and the plateaus 20p, 20p′ of the duct webs 20s, 20s′ in the embodiment in FIG. 6 are selected in such a way as to provide a tapering progression for the duct webs 20s, 20s′ toward the side facing away from the duct floor 20b, 20b′, in which an angle of inclination α of the respective duct wall 20w, 20w′ is different than 0°, so that Bsb>Bsp.

FIG. 7 presents a diagrammatic and perspective exploded view of a configuration 100′ for a plate heat exchanger 100 with a plurality of heat exchanger plates 1 or 1j, where j=1, . . . , n according to the invention, which are disposed so as to cover or be congruent with each other to resemble a stack 110, and alternately generate flow spaces R1, R3, R5, . . . for the first fluid F1 or R2, R4, R6, . . . for the second fluid F2. An allocation of the gaps or flow spaces R1, R2, R3, . . . of directly adjacent heat exchanger plates 1 or 1j, j=1, . . . , n according to the invention, relative to the corresponding first and second fluids F1, F2, is also denoted. The arrows denote the flow conditions with respect to forward and return flow, i.e., inflow and outflow. The respective gaskets 6, 4-1, 4-2 and various duct configurations 20, 20′ are not indicated in this illustration.

FIGS. 8A to 8D diagrammatically present fragmentary side and top views of flow conditions present in the configuration 100′ in FIG. 7 with respect to the first and second fluids F1 and F2. First and second secondary gaskets 4-1, 4-2, 4-1′, 4-2′ for the first and second fluids F1, F2 are exclusively shown therein.

As is evident from the information provided for FIGS. 7 to 8D, stringing together and interconnecting a plurality of heat exchanger plates 1 or 1j, j=1, . . . , n according to the invention yields a sequence of alternating flow spaces for the first and second fluids F1 and F2, wherein consecutive, odd numbered gaps R1, R3, R5, . . . between directly consecutive heat exchanger plates 1 or 1j, j=1, . . . , n form flow spaces R1, R3, R5, . . . for the first fluid F1, while even numbered gaps R2, R4, R6, . . . between consecutive heat exchanger plates 1 or 1j, j=1, . . . , n form flow spaces R2, R4, R4, . . . for the second fluid F2.

The illustrations in FIGS. 8A to 8D are not to scale therein, since the primary gaskets 6, 6′ and secondary gaskets 4-1, 4-2, 4-1′, 4-2′ have too thick a configuration. However, this serves to illustrate the geometric and flow conditions.

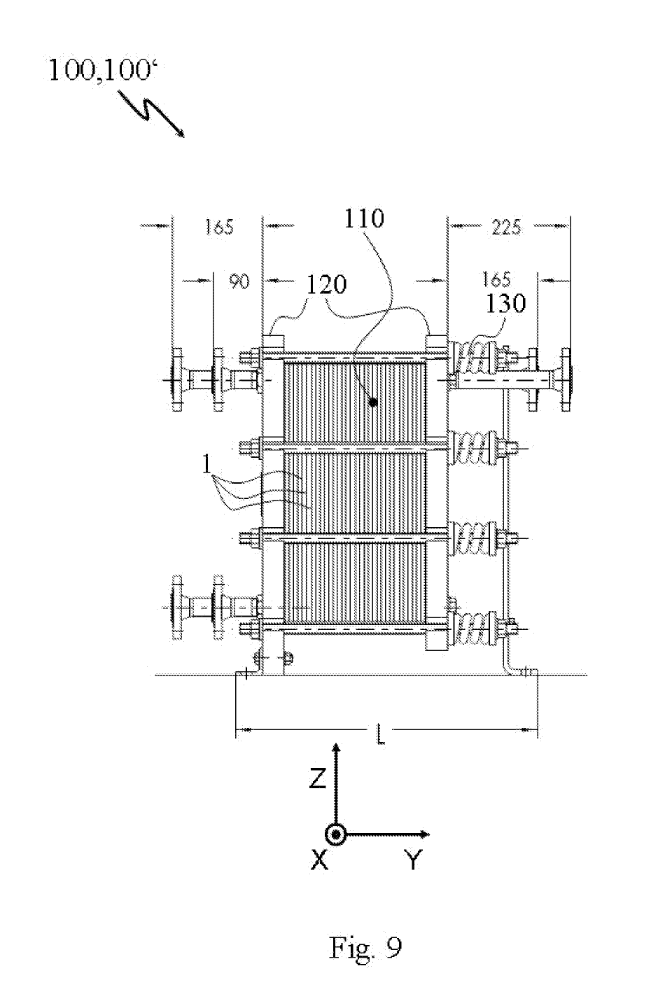

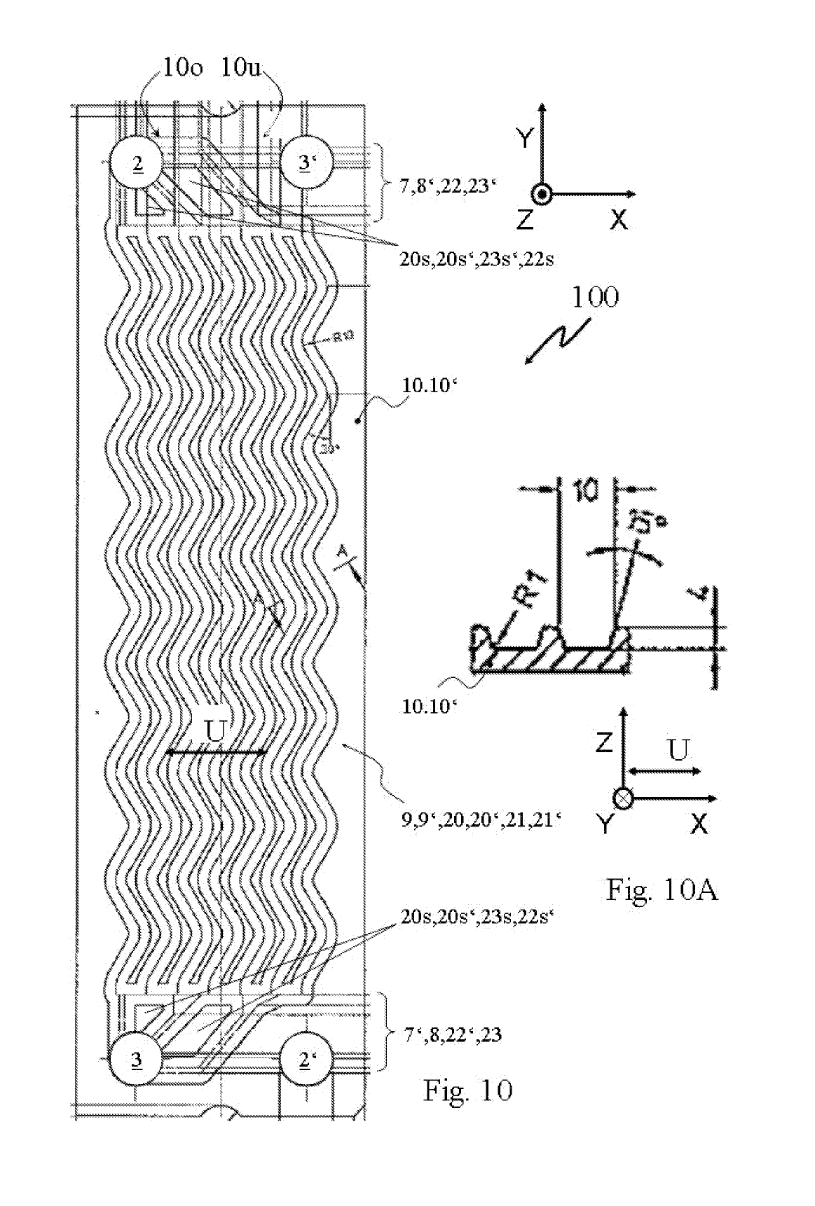

FIG. 9 presents a diagrammatic and partially fragmentary side view of a more realistic depiction of the configuration 100′ of a plate heat exchanger 100 according to the invention with a plurality of heat exchanger plates 1 or 1j, j=1, . . . , n according to the invention combined into a stack 110.

The stack 110 formed of a plurality of heat exchanger plates 1 or 1j, j=1, . . . , n according to the invention in this case is clamped between two clamping plates 120 or clamping devices 120 through a corresponding screw joint 130, so that the conditions described with regard to the preceding figures come about as a whole during the interaction between the individual heat exchanger plates 1 or 1j, j=1, . . . , n according to the invention.

FIGS. 10 and 10A illustrate another embodiment of the heat exchanger plate 1 according to the invention that contains or is formed of a ceramic substrate 10.

The heat exchanger plate 1 according to the invention in this case also has a substantially rectangular configuration, but with an edge ratio between the long and short edges I or k measuring about 4:1. Otherwise, the conditions are as described in conjunction with FIGS. 2A, 2B and 4 as well as 6. This means that the actual primary heat exchange ducts 21k, 21k′ are approximately wave shaped, that no 1-to-1 correspondence or allocation exists between the supply and removal ducts 22k, 22k′, 23k, 23k′ on one hand and the primary heat exchange ducts 21k, 21k′ on the other hand, and that the webs 20s, 20s′, meaning, in particular, 22s, 22s′, 23s, 23s′, of the underlying flow ducts 20k, 20k′ have a trapezoidal shape in cross section, with a tapering progression going away from the respective duct floor 20b, 20b′.

1. A heat exchanger plate for a plate heat exchanger, the heat exchanger plate comprising:
a plate substrate containing or formed of an SiC material or a silicon carbide material and having a front or upper side and a rear or bottom side;
at least said front or upper side of said plate substrate formed with a flow duct configuration having a plurality of flow ducts; and
some or all of said flow ducts of said flow duct configuration being entirely or sectionally provided with duct webs bordering duct grooves and forming duct walls.

2. The heat exchanger plate according to claim 1, wherein said plate substrate contains or is formed of a sintered silicon carbide material or SSiC material.

3. The heat exchanger plate according to claim 1, wherein said plate substrate has at least one of a minimal layer thickness Dmin or an average layer thickness Dm ranging between about 2 mm and about 4 mm, or measuring about 3 mm or less or measuring about 2 mm.

4. The heat exchanger plate according to claim 3, wherein said plate substrate has a layer thickness Ds in vicinity of a duct web being greater than at least one of said minimum layer thickness Dmin or said average layer thickness Dm, thereby:
approximately satisfying a correlation Ds≧Dmin, or
approximately satisfying a correlation Ds≧Dm.

5. The heat exchanger plate according to claim 1, wherein:
said flow duct has a local direction;
said duct groove of said flow duct has a floor with a local width Bb and said duct web of said flow duct has a base with a local width Bsb at a height of said floor of said duct groove of said flow duct, each measured perpendicular to said local direction of said flow duct; and
said local widths Bb, Bsb are in a ratio Bb:Bsb of about 1:4, thereby approximately satisfying a correlation Bb:Bsb=10:4.

6. The heat exchanger plate according to claim 1, wherein:
said flow duct has a local direction;
said duct groove of said flow duct has a floor with a local width Bb and said duct web of said flow duct has a plateau with a local width Bsp on a side facing away from said floor of said duct groove of said flow duct, each measured perpendicular to said local direction of said flow duct; and
said widths Bb, Bsp are in a ratio Bb:Bsp within a range of about 10:3, thereby:
approximately satisfying a correlation 10:4≦Bb:Bsp≦10:2, or
approximately satisfying a correlation Bb:Bsp=10:3.

7. The heat exchanger plate according to claim 1, wherein:
said flow duct has a local direction;
said duct groove of said flow duct has a floor, said duct web of said flow duct has a base with a local width Bsb at a height of said floor of said duct groove and said duct web of said flow duct has a plateau with a local width Bsp on a side facing away from said floor of said duct groove of said flow duct, each measured perpendicular to said local direction of said flow duct; and
said widths Bsb, Bsp are in a ratio Bsb:Bsp ranging from about 1:1 to about 4:2 or are about 4:3, thereby:
approximately satisfying a correlation 4:2≦Bsb:Bsp≦1:1, or
approximately satisfying a correlation Bsb:Bsp=4:3.

8. The heat exchanger plate according to claim 1, wherein:
said duct groove of said flow duct has a floor; and
said duct walls of said flow duct include an angle α with a normal to said floor of said duct groove of said flow duct ranging from greater than 0° to less than 30° or lying at about 15°, thereby:
approximately satisfying a correlation 0°<α≦30°, or
approximately satisfying a correlation α=15°.

9. The heat exchanger plate according to claim 1, wherein:
said flow duct has a local direction;
said duct groove of said flow duct has a floor with a local width Bb measured perpendicular to said local direction of the flow duct and said duct groove of said flow duct has a depth t measured perpendicular to said floor of said duct groove of said flow duct; and
said width Bb and said depth t are in a ratio Bb:t ranging from about 10:10 to about 10:4 or are about 10:4, thereby:
approximately satisfying a correlation 10:10≦Bb:t≦10:4, or
approximately satisfying a correlation Bb:t=10:4.

10. The heat exchanger plate according to claim 1, which further comprises:
supply and removal openings penetrating said plate substrate from said upper side to said bottom side for supplying or removing a first heat exchange fluid to or from said upper side of said plate substrate;
said flow duct configuration configured to transport the first heat exchange fluid from said supply opening to said removal opening.

11. The heat exchanger plate according to claim 1, wherein:
all or sections of said flow ducts of said flow duct configuration have a multi-undulating progression with an undulating direction; and
said undulating direction runs at least one of in a surface or plane defined by said plate substrate or perpendicular to a flow direction defined by said respective flow duct at least one of locally or on average.

12. The heat exchanger plate according to claim 11, wherein said multi-undulating progression has an undulation shape for a respective flow duct selected from a group of shapes including sawtooth shapes, alternating stepped shapes, wave shapes, sinus shapes and combinations thereof.

13. The heat exchanger plate according to claim 1, wherein said rear or bottom side of said plate substrate has a second flow duct configuration for a second heat exchange fluid with a plurality of corresponding flow ducts.

14. The heat exchanger plate according to claim 13, which further comprises:
second supply and removal openings penetrating said plate substrate from said upper side to said bottom side for supplying or removing the second heat exchange fluid to or from said rear or bottom side of said plate substrate;
said second flow duct configuration being configured to transport the second heat exchange fluid from said second supply opening to said second removal opening.

15. The heat exchanger plate according to claim 1, wherein the heat exchanger plate is rotationally symmetrical over 180° with respect to said front or upper side and said rear or bottom side relative to a symmetry axis running in said plate substrate.

16. The heat exchanger plate according to claim 1, wherein:
said plate substrate has a substantially rectangular shape;
at least one of said supply or removal openings is formed in vicinity of opposing first or shorter sides of said rectangular shape; and
directions in which at least one of the first or second heat exchange fluids flow and/or primary directions in which said flow ducts extend, are substantially formed along directions in which opposing second or longer-sides of the rectangular shape extend.

17. A plate heat exchanger, comprising:
a plurality of adjacent heat exchanger plates according to claim 1 constructed and disposed to precede and follow one another in a sequence;
said rear or bottom side of said plate substrate of a respective preceding heat exchanger plate lying directly opposite or directly abutting against said front or upper side of said plate substrate of a respective directly following heat exchanger plate or with a sealing configuration therebetween;
at least one of said sequence of said heat exchanger plates or a formation of said sealing configuration directly forming sequential through-flow spaces separated from each other in terms of flow;
directly adjacent through-flow spaces being separated in pairs in terms of flow; and
respective alternating adjacent through-flow spaces joined together in pairs in terms of flow each being allocated to a respective heat exchange fluid and configured to allow the respectively allocated heat exchange fluid to flow from said respective supply opening to said respective removal opening.

18. A method for manufacturing a heat exchanger plate for a plate heat exchanger, the method comprising the following steps:
providing or forming a plate substrate containing or formed of an SiC material or a silicon carbide material with a front or upper side and a rear or bottom side;
forming a flow duct configuration with a plurality of flow ducts on the front or upper side of the plate substrate; and
forming some or all of the flow ducts of the flow duct configuration entirely or sectionally with duct webs bordering duct grooves and forming duct walls.

19. The method according to claim 18, wherein the plate substrate contains or is formed of a sintered silicon carbide material or SSiC material.

20. The method according to claim 18, which further comprises:
constructing the flow ducts of the flow duct configuration with a flow direction and a completely or sectionally multi-undulating progression having an undulating direction;
configuring the undulating direction to run at least one of in a surface or plane defined by the plate substrate or perpendicular to the flow direction defined by the flow duct locally or on average; and
selecting a shape of an undulation of the multi-undulating progression from a group of shapes including sawtooth shapes, alternating stepped shapes, wave shapes, sinus shapes and combinations thereof.
